(19) United States
(12) Patent Application Publication
(10) Pub. No.: US 2016/0110401 A1
(43) Pub. Date: Apr. 21, 2016

(54) Data Management Method and Device

(71) Applicant: Huawei Technologies Co., Ltd., Shenzhen (CN)

(72) Inventors: Mingxuan Yuan, Hong Kong (HK); Jia Zeng, Hong Kong (HK); Shiming Zhang, Shenzhen (CN)

(21) Appl. No.: 14/980,947

(22) Filed: Dec. 28, 2015

Related U.S. Application Data
(63) Continuation of application No. PCT/CN2014/075306, filed on Apr. 14, 2014.

(30) Foreign Application Priority Data
Nov. 13, 2013 (CN) 201310567072.X

(51) Int. Cl. G06F 17/30

(52) U.S. Cl. CPC G06F 17/30345; G06F 17/30554

(57) ABSTRACT

A data management method and device are disclosed. The data management method includes acquiring data published by a first user on the Internet and a shared domain of the data; expressing the data published by the first user as user data in a uniform format; and transforming, using a visualization technology, the user data in the uniform format into a graph or an image having a relationship between time and space for display. In the foregoing manner, user data can be visually reflected, such that a user can comprehensively evaluate and manage data of the user, thereby effectively ensuring security of the user data.

### CROSS-REFERENCE TO RELATED APPLICATIONS

This application is a continuation of International Application No. PCT/CN2014/075306, filed on Apr. 14, 2014, which claims priority to Chinese Patent Application No. 201310567072.X, filed on Nov. 13, 2013, both of which are hereby incorporated by reference in their entireties.

### TECHNICAL FIELD

The present disclosure relates to the field of computer science, and in particular, to a data management method and device.

### BACKGROUND

A user data protection technology is an important research subject in directions of a database, data mining, and Internet data management in the field of computer science. The technology focuses on a research about how to manage data of a user so that private data of the user is protected while useful data is being published and shared. As social networks and mobile Internet terminals are used widely, more user data is provided for an Internet service provider, and user data protection becomes an important problem to be solved urgently at present.

According to existing methods and tools for protecting user data, a leakage situation of the user data cannot be visually reflected, so that the user cannot know which data of the user is leaked and needs to be protected, and security of the user data cannot be effectively ensured.

### SUMMARY

The present application mainly solves a technical problem by providing a data management method and device, which can visually reflect user data, such that a user can comprehensively evaluate and manage data of the user, thereby effectively ensuring security of the user data.

According to a first aspect, the present application provides a data management method, including acquiring data published by a first user on the Internet and a shared domain of the data; expressing the data published by the first user as user data in a uniform format; and transforming, using a visualization technology, the user data in the uniform format into a graph or an image having a relationship between time and space for display, where the graph or the image is a graph or an image having a relationship between time and space at a visual angle of a second user specified in the shared domain of the data.

With reference to the first aspect, in a first possible implementation manner of the first aspect, the method further includes receiving an operation instruction for adjusting the graph or the image; returning, according to the operation instruction, setting options for adjusting the user data corresponding to the graph or the image; and receiving an instruction of a selected setting option, and adjusting the user data corresponding to the graph or the image.

With reference to the first possible implementation manner of the first aspect, in a second possible implementation manner of the first aspect, after the step of returning, according to the operation instruction, setting options for adjusting the user data corresponding to the graph or the image, the method further includes presenting, using the visualization technology, adjustment effects corresponding to the setting options to the user to preview.

With reference to the first aspect, in a third possible implementation manner of the first aspect, the step of transforming, using a visualization technology, the user data in the uniform format into a graph or an image having a relationship between time and space at a visual angle of a second user specified in the shared domain of the data for display includes transforming, using the visualization technology and in combination with an electronic map function, the user data in the uniform format into the graph or the image having the relationship between time and space at the visual angle of the second user specified in the shared domain of the data for display.

With reference to the first aspect, in a fourth possible implementation manner of the first aspect, the data published by the first user includes explicit data and implicit data.

With reference to the fourth possible implementation manner of the first aspect, in a fifth possible implementation manner of the first aspect, the explicit data includes information covered by a data protection setting, and the implicit data includes information included in a text, a picture, and a video that are shared by the user.

With reference to the first aspect or any possible implementation manner of the first aspect, in a sixth possible implementation manner of the first aspect, the step of expressing the data published by the first user as user data in a uniform format includes expressing the data published by the first user as user data in a uniform format of “who, when, where, and about what is shared to whom”.

According to a second aspect, a data management device is provided, including an acquiring module, an expressing module, and a displaying module, where the acquiring module is configured to acquire data published by a first user on the Internet and a shared domain of the data, and output the data and the shared domain to the expressing module; the expressing module is configured to express the data published by the first user as user data in a uniform format, and output the user data in the uniform format to the displaying module; and the displaying module is configured to transform, using a visualization technology, the user data in the uniform format into a graph or an image having a relationship between time and space for display, where the graph or the image is a graph or an image having a relationship between time and space at a visual angle of a second user specified in the shared domain of the data.

With reference to the second aspect, in a first possible implementation manner of the second aspect, the device further includes a receiving module, a returning module, and an adjusting module, where the receiving module is configured to receive an operation instruction for adjusting the graph or the image, and output the operation instruction to the returning module; the returning module is configured to return, according to the operation instruction, setting options for adjusting the user data corresponding to the graph or the image; and the adjusting module is configured to receive an instruction of a selected setting option, and adjust the user data corresponding to the graph or the image.

With reference to the first possible implementation manner of the second aspect, in a second possible implementation manner of the second aspect, the returning module is further configured to present, using the visualization technology, adjustment effects corresponding to the setting options to the user to preview.

With reference to the second aspect, in a third possible implementation manner of the second aspect, the displaying module is configured to transform, using the visualization technology and in combination with an electronic map function, the user data in the uniform format into the graph or the image having the relationship between time and space at the visual angle of the second user specified in the shared domain of the data for display.

With reference to the second aspect, in a fourth possible implementation manner of the second aspect, the data published by the first user includes explicit data and implicit data.

With reference to the fourth possible implementation manner of the second aspect, in a fifth possible implementation manner of the second aspect, the explicit data includes information covered by a data protection setting, and the implicit data includes information included in a text, a picture, and a video that are shared by the user.

With reference to the second aspect or any possible implementation manner of the second aspect, in a sixth possible implementation manner of the second aspect, the expressing module is configured to express the data published by the first user as user data in a uniform format of “who, when, where, and about what is shared to whom”.

Beneficial effects of the present application are as follows. A difference from a situation in the prior art lies in that, in the present application, data published by a first user in each data source on the Internet and a shared domain of the data are acquired, the data published by the first user is expressed as user data in a uniform format, and the user data in the uniform format is then transformed into a graph or an image having a relationship between time and space at a visual angle of a second user specified in the shared domain for display. In this way, a user can visually read and understand a publishing situation of user data, such that the user can comprehensively evaluate and manage data of the user in a timely manner to prevent leakage, thereby effectively ensuring security of the user data and providing better experience for the user.

### BRIEF DESCRIPTION OF DRAWINGS

FIG. 1 is a flowchart of an implementation manner of a data management method according to the present application;

FIG. 2 is a flowchart of another implementation manner of a data management method according to the present application;

FIG. 3 is a schematic structural diagram of an implementation manner of a data management device according to the present application;

FIG. 4 is a schematic structural diagram of another implementation manner of a data management device according to the present application; and

FIG. 5 is a schematic structural diagram of still another implementation manner of a data management device according to the present application.

### DESCRIPTION OF EMBODIMENTS

A user data protection technology is an important research subject in directions of a database, data mining, and Internet data management in the field of computer science. The technology focuses on a research about how to manage data of a user such that private data of the user is protected while useful data is being published and shared. As social networks and mobile Internet terminals are used widely, more user data is provided for an Internet service provider, and user data protection becomes an important problem to be solved urgently at present.

The user data protection technology may be classified into two types: publishing/management of privacy preservation data and management of privacy of an online user. The publishing/management of the privacy preservation data focuses on a research about how to publish/manage the data of the user such that a data analysis worker cannot acquire sensitive information of an individual user while acquiring a useful statistical result. The management of the privacy of the online user focuses on a research about how to assist the user in managing online information of the user such that the user well protects the privacy of the user while effectively sharing information.

The publishing/management of the privacy preservation data has two basic technologies: publishing of the privacy preservation data and differential privacy protection. The publishing of the privacy preservation data refers to publishing processed (noised or coarse-grained) data instead of original data to a data analysis worker. When the data is processed, it needs to make an assumption about background knowledge of an attacker and a privacy protection target. A most representative manner is a K-anonymity algorithm, that is, by performing coarse granulation on data, identifiable information of each user is changed into information the same as that of other at least K-1 users. Disadvantages of the current method are as follows: (1) It needs to make an assumption about background knowledge of an attacker, and if the assumption is improper, a model may fail totally; (2) availability of published data cannot be ensured at all. The differential privacy protection provides a query interface for a data analyst. The data analyst cannot directly access data, but only can make an analysis using a result of an aggregate query provided by the interface. The interface adds noise to the result of the query to ensure that information of any individual is not leaked. A method for the differential privacy protection has two main problems: (1) Because of excessive protection, impact of the result of the aggregate query on analysis accuracy is difficult to define; (2) only a limited quantity of queries can be supported, and it is difficult to support a complex data mining task.

Two problems are mainly researched in the management of the privacy of the online user: (1) How to design a friendly setting tool for user privacy protection such that a user manages personal information of the user conveniently; (2) how to enable the user to understand and evaluate a publishing situation of data information of the user. With increasing use of the Internet, Internet services become more widespread and diversified. A large amount of data of a user is provided for a service provider to acquire a corresponding service. How to manage and publish the information becomes important. At present, different service providers, for example, a social networking site, provide different setting tools for private data protection to assist the user in setting a policy of publishing the data of the user. However, because of diversity of information and a complex rule of information protection, it is difficult for the user to understand and use these tools. In a current research, it is considered that a learning algorithm is used to classify the data of the user, so as to simplify a setting. However, the user still needs to understand and learn a protection rule before using these tools. There is another protection method in which a leakage index of private data is calculated according to personal data published by a user, and when the index is lower than a specific threshold, the user is reminded of strengthening a protection policy for the data of the user. A main problem of this method is that the index cannot visually reflect a leakage situation of the data of the user. The user cannot see which private data needs protection and how to protect the private data. Another important problem is that a current method for managing private data of an online user is intended to protect only one data source, but is not applicable to a situation in which the current user often uses multiple Internet services.

The present application aims at solving a defect in an existing user data protection technology, and provides a data management method and device, which can visually reflect user data, such that a user can comprehensively evaluate and manage data of the user, thereby effectively ensuring security of the user data.

The following further explains and describes the technical solutions of the present application with reference to implementation manners. However, the implementation manners are merely implementation manners of the data management method and device of the present application, but are not intended to limit the protection scope of the present application.

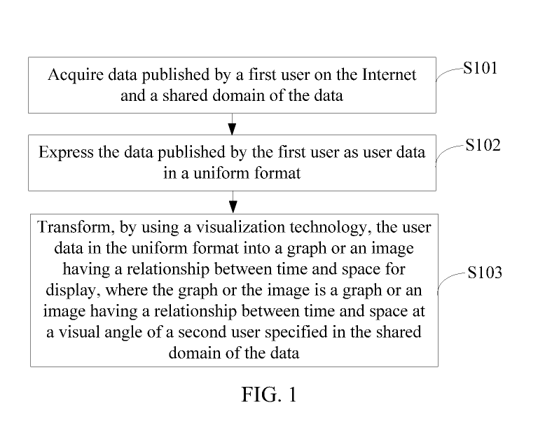

Referring to FIG. 1, FIG. 1 is a flowchart of an implementation manner of a data management method according to the present application. The data management method in this implementation manner is described from a perspective of a data management device that implements the data management method. The data management method in this implementation manner includes the following steps.

Step S101: Acquire data published by a first user on the Internet and a shared domain of the data.

The data management device acquires the data published by the first user on the Internet and the shared domain of the data. Herein, the data published by the first user includes data published by the first user in each data source. The shared domain refers to a sharing range allowed for the data published by the first user, that is, the shared domain can reflect who has a permission to read the data.

The acquired data published by the first user includes explicit data and implicit data.

The explicit data includes information, such as a user's profile, interest, age, occupation and check-in data, that may be covered by a data protection setting engine.

The implicit data includes information included in a text, a picture, a video, and the like that are shared by the first user. For example, either information about drinking with a friend published by the user on the facebook or information about drinking with the user that is published by a friend of the user and is shared by the user includes information indicating that the user drinks in a particular period of time.

Step S102: Express the data published by the first user as user data in a uniform format.

In the data published by the first user, the explicit data is structured information. The explicit data is provided for different service providing programs and displayed in formats of the service providing programs. For example, the data management device may establish a metadata expression of the explicit data and express the explicit data in a uniform format in a metadata expression manner.

Information about the implicit data is implied in various unstructured information published by the first user. Because Internet information meets a 4A (Anyone, Anytime, Anywhere, Anything) feature, the unstructured information may be uniformly identified as when, where, who, and about what is shared to whom. Therefore, an expression format of the implicit data is designed as Who, When, Where and What to Whom. Each piece of implicit information can be expressed in this format.

Meanwhile, the uniform format of the explicit data is also transformed into this format. The explicit data includes the first user's data related to time, space, and a social relationship. For example, the check-in data may be expressed in the designed expression format. In this way, the explicit data and the implicit data that are published by the first user on the Internet are both expressed in a uniform format.

Step S103: Transform, using a visualization technology, the user data in the uniform format into a graph or an image having a relationship between time and space for display, where the graph or the image is a graph or an image having a relationship between time and space at a visual angle of a second user specified in the shared domain of the data.

The visualization technology refers to a theory, a method, and a technology in which computer graphics and an image processing technology are used to transform data into a graph or an image for display on a screen, and interactive processing is performed. The user data in the uniform format is transformed, using the visualization technology, into the graph or the image having the relationship between time and space at the visual angle of the second user specified in the shared domain of the data for display. The second user herein includes all users who share the data published by the first user.

The user data is displayed from visual angles of different users using the visualization technology, such that the first user can visually read and understand a publishing situation of the data of the user.

According to the description of the foregoing implementation manner, it may be understood that, in the data management method of the present application, data published by a first user in each data source on the Internet and a shared domain of the data are acquired, the data published by the first user is expressed as user data in a uniform format, and the user data in the uniform format is then transformed into a graph or an image having a relationship between time and space at a visual angle of a second user specified in the shared domain for display. In this way, a user can visually read and understand a publishing situation of user data; transparency between the user and the data of the user is implemented; and the user data is presented from visual angles from which different users observe the user, such that the user can comprehensively evaluate and manage the data of the user in a timely manner to prevent leakage, thereby effectively ensuring security of the user data and providing better experience for the user.

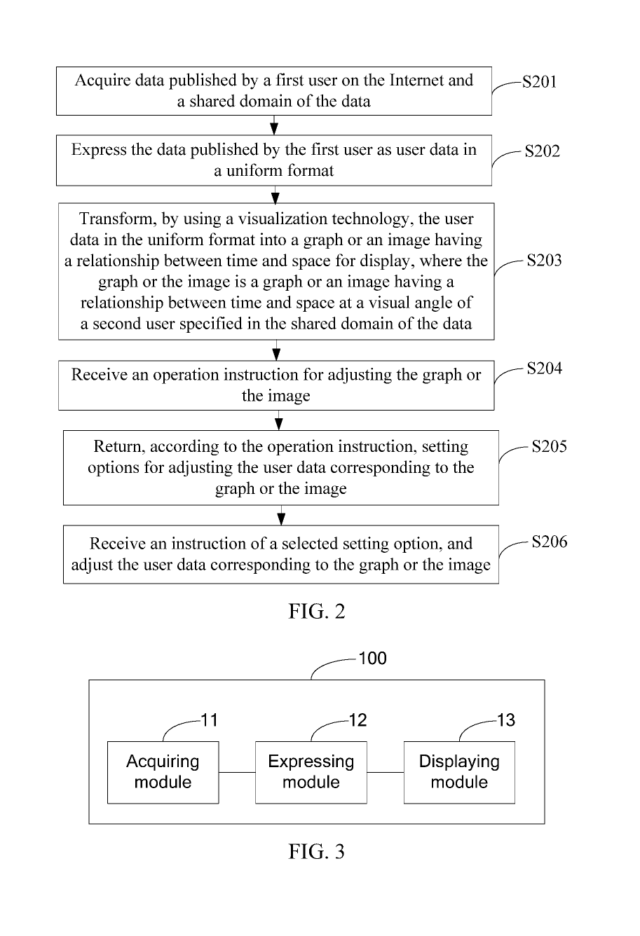

Referring to FIG. 2, FIG. 2 is a flowchart of another implementation manner of a data management method according to the present application. The data management method in this implementation manner is described from a perspective of a data management device that implements the data management method. The data management method in this implementation manner includes the following steps.

Step S201: Acquire data published by a first user in each data source on the Internet and a shared domain of the data.

The data management device acquires the data published by the first user on the Internet and the shared domain of the data. The data published by the first user includes data published by the first user in each data source on the Internet. The shared domain herein refers to a sharing range allowed for the data published by the first user, that is, the shared domain can reflect who has a permission to read the data.

The acquired data published by the first user includes explicit data and implicit data.

The explicit data includes information, such as a user's profile, interest, age, occupation and check-in data, that may be covered by a data protection setting engine.

The implicit data includes information included in a text, a picture, a video, and the like that are shared by the user. For example, either information about drinking with a friend published by the user on the facebook or information about drinking with the user that is published by a friend of the user and is shared by the user includes information indicating that the user drinks in a particular period of time.

Step S202: Express the data published by the first user as user data in a uniform format.

In the data published by the first user, the explicit data is structured information. The explicit data is provided for different service providing programs and displayed in formats of the service providing programs. For example, the data management device may establish a metadata expression of the explicit data and express the explicit data in a uniform format in a metadata expression manner.

Information about the implicit data is implied in various unstructured information published by the first user. Because Internet information meets the 4A feature, the unstructured information may be uniformly identified as when, where, who, and about what is shared to whom. Therefore, an expression format of the implicit data is designed as Who, When, Where and What to Whom. Each piece of implicit information can be expressed in this format.

Meanwhile, the uniform format of the explicit data is also transformed into this format. The explicit data includes the first user's data related to time, space, and a social relationship. For example, the check-in data may be expressed in the designed expression format. In this way, the explicit data and the implicit data that are published by the first user on the Internet are both expressed in a uniform format.

Step S203: Transform, using a visualization technology, the user data in the uniform format into a graph or an image having a relationship between time and space for display, where the graph or the image is a graph or an image having a relationship between time and space at a visual angle of a second user specified in the shared domain of the data.

The user data in the uniform format is transformed, using the visualization technology, into the graph or the image having the relationship between time and space at the visual angle of the second user specified in the shared domain of the data for display. The second user herein includes all users who share the data published by the first user.

To display the data published by the first user using the graph or the image having the relationship between time and space more vividly and visually, on the basis of the visualization technology and in combination with an electronic map function, the user data in the uniform format is displayed on an electronic map using the graph or the image having the relationship between time and space at the visual angle of the specified second user.

Step S204: Receive an operation instruction for adjusting the graph or the image.

If the first user finds, on a displayed graph or image at a visual angle, information indicating that the first user does not want the second user at the visual angle to see, or the first user wants the second user at the visual angle to see information that is not displayed on the graph or the image, in this case, an operation may be performed on a graph or an image in a visual display interface. The data management device receives the operation instruction for adjusting the graph or the image by the first user.

For example, in a period of time and in a graph or an image displayed at a visual angle of a supervisor of the first user, if the first user finds, during a sick leave period of the first user, that there is a path that connects to a bar, the first user can visually find that corresponding data has been leaked. The leakage may be data leakage caused by the first user, or may be caused by data sharing by a friend of the first user. In this case, the path that connects to the bar in a display interface may be directly erased to prevent the supervisor from seeing the part of data information about the bar.

Step S205: Return, according to the operation instruction, setting options for adjusting the user data corresponding to the graph or the image.

According to the operation instruction, an analysis engine in the background of a data management device system automatically finds setting options for correspondingly adjusting to-be-adjusted user data corresponding to the graph or the image, and feeds back the setting options to the user for the user to select.

For example, according to an operation instruction for erasing, by the user, the path that connects to the bar in the display interface, the data management device system finds user data (that is, original data) corresponding to the erased graph or image. Cancelling one or more permissions of the supervisor to read the original data may achieve a protection effect expected by the user. The system automatically obtains, by means of calculation, all solutions that can achieve a protection effect, and generates the setting options for adjusting the user data corresponding to the graph or the image. One adjustment solution corresponds to one setting option returned to the user. For example, there are two data sources, which are a first data source and a second data source, where the two data sources correspond to the path that connects to the bar. Cancelling a permission of the supervisor to read the first data source or cancelling a permission of the supervisor to read the second data source can both achieve a protection effect (cancelling both the permissions of the supervisor to read the first and the second data sources is another solution, which may also achieve a protection effect; however, in a case of achieving a same protection effect, an information loss in this solution is greater than that in other solutions; therefore, the system automatically filters out this solution, and returns only a setting option corresponding to a preferable solution that can achieve a required effect).

On the other hand, to help direct the user to select a setting option, the system may present, using the visualization technology, adjustment effects corresponding to the returned setting options to the user to preview. The user selects one of the setting options according to the previewed adjustment effects.

Step S206: Receive an instruction of a selected setting option, and adjust the user data corresponding to the graph or the image.

The data management device further receives the instruction of the setting option selected by the user, and correspondingly adjusts the user data corresponding to the graph or the image. In this way, the system controls a permission on a corresponding data source according to selection of the user. Using this mechanism, automatic adjustment and protection of privacy of the user are implemented for the user. For example, the user erases the path that connects to the bar in the display interface, and hidden adjustment is performed on all user data, such as time, a location, and event information, that corresponds to the path that connects to the bar at the visual angle.

According to the foregoing implementation manner, further, a user can directly perform an operation of erasing or displaying a graph or an image in a display interface, so as to adjust data of the user. This manner is easy to implement and enables the operation to be more convenient and direct, thereby more effectively protecting user data and providing better experience for the user.

Referring to FIG. 3, FIG. 3 is a schematic structural diagram of an implementation manner of a data management device according to the present application. A data management device 100 in this implementation manner includes an acquiring module 11, an expressing module 12, and a displaying module 13.

The acquiring module 11 is configured to acquire data published by a first user on the Internet and a shared domain of the data, and output the data and the shared domain to the expressing module 12.

The acquiring module 11 acquires the data published by the first user on the Internet and the shared domain of the data. The data published by the first user includes data published by the first user in each data source on the Internet. The shared domain herein refers to a sharing range of the data published by the first user in each data source, that is, the shared domain can reflect who has a permission to read the data.

The acquired data published by the first user includes explicit data and implicit data.

The explicit data includes information, such as a user's profile, interest, age, occupation and check-in data, that may be covered by a data protection setting engine.

The implicit data includes information included in a text, a picture, a video, and the like that are shared by the first user. For example, either information about drinking with a friend published by the user on the facebook or information about drinking with the user that is published by a friend of the user and is shared by the user includes information indicating that the user drinks in a particular period of time.

The expressing module 12 is configured to express the data published by the first user as user data in a uniform format, and output the user data in the uniform format to the displaying module 13.

In the data published by the first user, the explicit data is structured information. The explicit data is provided for different service providing programs and displayed in formats of the service providing programs. For example, the expressing module 12 may establish a metadata expression of the explicit data and express the explicit data in a uniform format in a metadata expression manner.

Information about the implicit data is implied in various unstructured information published by the first user. Because Internet information meets the 4A feature, the unstructured information may be uniformly identified as when, where, who, and about what is shared to whom. Therefore, an expression format of the implicit data is designed as Who, When, Where and What to Whom. Each piece of implicit information can be expressed in this format by the expressing module 12.

Meanwhile, the expressing module 12 also transforms the uniform format of the explicit data into this format. The explicit data includes the first user's data related to time, space, and a social relationship. For example, the check-in data may be expressed in the designed expression format. In this way, the explicit data and the implicit data that are published by the first user on the Internet are both expressed in a uniform format.

The displaying module 13 is configured to transform, using a visualization technology, the user data in the uniform format into a graph or an image having a relationship between time and space for display, where the graph or the image is a graph or an image having a relationship between time and space at a visual angle of a second user specified in the shared domain of the data.

The visualization technology refers to a theory, a method, and a technology in which computer graphics and an image processing technology are used to transform data into a graph or an image for display on a screen, and interactive processing is performed. The displaying module 13 transforms, using the visualization technology, the user data in the uniform format into the graph or the image having the relationship between time and space at the visual angle of the second user specified in the shared domain of the data for display. The second user herein includes all users who share the data published by the first user.

To display the data published by the first user as the relationship between time and space more vividly and visually, the displaying module 13 may display, on the basis of the visualization technology and in combination with an electronic map function, the user data in the uniform format on an electronic map using the graph or the image having the relationship between time and space at the visual angle of the specified second user.

The displaying module 13 displays the first user data from visual angles of different users using the visualization technology, such that the first user can visually read and understand a publishing situation of the data of the first user.

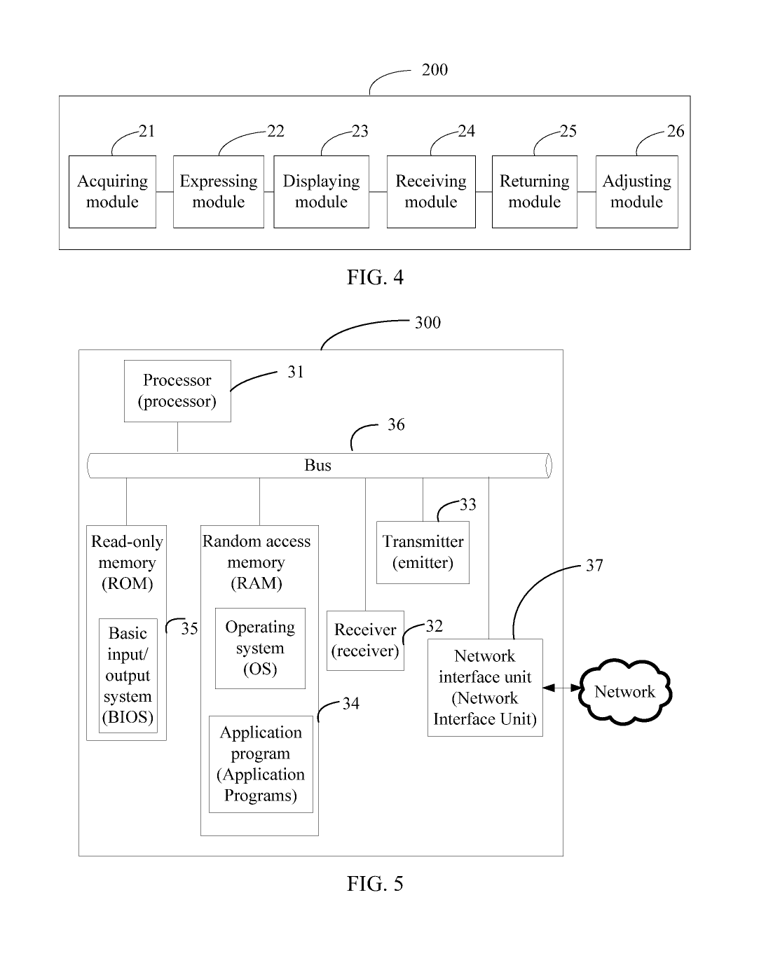

Referring to FIG. 4, FIG. 4 is a schematic structural diagram of another implementation manner of a data management device according to the present application. A data management device 200 in this implementation manner includes an acquiring module 21, an expressing module 22, a displaying module 23, a receiving module 24, a returning module 25, and an adjusting module 26.

The acquiring module 21 is configured to acquire data published by a first user on the Internet and a shared domain of the data, and output the data and the shared domain to the expressing module 22.

The expressing module 22 is configured to express the data published by the first user as user data in a uniform format, and output the user data in the uniform format to the displaying module 23.

The displaying module 23 is configured to transform, using a visualization technology, the user data in the uniform format into a graph or an image having a relationship between time and space for display, where the graph or the image is a graph or an image having a relationship between time and space at a visual angle of a second user specified in the shared domain of the data.

The receiving module 24 is configured to receive an operation instruction for adjusting the graph or the image, and output the operation instruction to the returning module 25.

If the first user finds, on a displayed graph or image at a visual angle, information indicating that the first user does not want the second user at the visual angle to see, or the first user wants the second user at the visual angle to see information that is not displayed on the graph or the image, in this case, an operation may be performed on a graph or an image in a visual display interface. The receiving module 24 receives the operation instruction for adjusting the graph or the image by the first user.

For example, in a period of time and in a graph or an image displayed at a visual angle of a supervisor of the first user, if the first user finds, during a sick leave period of the user, that there is a path that connects to a bar, the first user can visually find that corresponding data has been leaked. The leakage may be data leakage caused by the first user, or may be caused by data sharing by a friend of the first user. In this case, the path that connects to the bar in a display interface may be directly erased to prevent the supervisor from seeing the part of data information about the bar.

The returning module 25 is configured to return, according to the operation instruction, setting options for adjusting the user data corresponding to the graph or the image.

According to the operation instruction, an analysis engine in the background of a data management device system automatically finds setting options for correspondingly adjusting to-be-adjusted user data corresponding to the graph or the image, and feeds back, using the returning module 25, the setting options to the user for the first user to select.

For example, according to an operation instruction for erasing, by the user, the path that connects to the bar in the display interface, the data management device system finds user data (that is, original data) corresponding to the erased graph or image. Cancelling one or more permissions of the supervisor to read the original data may achieve a protection effect expected by the first user. The system automatically obtains, by means of calculation, all solutions that can achieve a protection effect, and generates the setting options for adjusting the user data corresponding to the graph or the image. One adjustment solution corresponds to one setting option returned to the user. For example, there are two data sources, which are a first data source and a second data source, where the two data sources correspond to the path that connects to the bar. Cancelling a permission of the supervisor to read the first data source or cancelling a permission of the supervisor to read the second data source can both achieve a protection effect (cancelling both the permissions of the supervisor to read the first and the second data sources is another solution, which may also achieve a protection effect; however, in a case of achieving a same protection effect, an information loss in this solution is greater than that in other solutions; therefore, the system automatically filters out this solution, and returns only a setting option corresponding to a preferable solution that can achieve a required effect).

On the other hand, to help direct the user to select a setting option, the returning module 25 may further present, using the visualization technology, adjustment effects corresponding to the returned setting options to the user to preview. The user selects one of the setting options according to the previewed adjustment effects.

The adjusting module 26 is configured to receive an instruction of a selected setting option, and adjust the user data corresponding to the graph or the image.

The adjusting module 26 receives the instruction of the setting option selected by the user, and correspondingly adjusts the user data corresponding to the graph or the image. In this way, the system controls a permission on a corresponding data source according to selection of the user. Using this mechanism, automatic adjustment and protection of privacy of the user are implemented for the user. For example, the user erases the path that connects to the bar in the display interface, and hidden adjustment is performed on all user data, such as time, a location, and event information, that corresponds to the path that connects to the bar at the visual angle.

Referring to FIG. 5, FIG. 5 is a schematic structural diagram of still another implementation manner of a data management device according to the present application. A data management device 300 in this implementation manner includes a processor 31, a receiver 32, a transmitter 33, a random access memory (RAM) 34, a read-only memory (ROM) 35, a bus 36, and a network interface unit 37. The processor 31 is coupled to the receiver 32, the transmitter 33, the RAM 34, the ROM 35, and the network interface unit 37 by the bus 36. When the data management device 300 needs to run, startup is performed using a basic input/output system (BIOS) that is fixedly located in the read-only memory 35 or a bootloader bootstrap system in an embedded system, to direct the data management device 300 to enter a normal running state. After the data management device 300 enters the normal running state, an application program and an operating system run in the random access memory 34, and data is received from a network or sent to a network using the network interface unit 37, such that:

The processor 31 is configured to acquire data published by a first user on the Internet and a shared domain of the data, express the data published by the first user as user data in a uniform format, and then transform the user data in the uniform format into a graph or an image having a relationship between time and space for display, where the graph or the image is a graph or an image having a relationship between time and space at a visual angle of a second user specified in the shared domain of the data.

To display the data published by the first user as the relationship between time and space more vividly and visually, the processor 31 may display, on the basis of a visualization technology and in combination with an electronic map function, the user data in the uniform format on an electronic map using the graph or the image having the relationship between time and space at the visual angle of the specified second user.

The receiver 32 is configured to receive an operation instruction for adjusting the displayed graph or image.

The processor 31 further returns, according to the operation instruction, setting options for adjusting the user data corresponding to the graph or the image, further receives an instruction of a setting option selected by the user, and adjusts the user data corresponding to the graph or the image.

The processor 31 in this implementation manner of the present application may be a central processing unit (CPU), or an application specific integrated circuit (ASIC), or one or more integrated circuits that are configured to implement this implementation manner of the present application.

According to the foregoing implementation manners, using the data management method and device in the present application, data published by a first user in each data source on the Internet and a shared domain of the data are acquired, the data published by the first user is expressed as user data in a uniform format, and the user data in the uniform format is then transformed into a graph or an image having a relationship between time and space at a visual angle of a second user specified in the shared domain for display. In this way, a user can visually read and understand a publishing situation of user data; transparency between the user and the data of the user is implemented; and the user data is presented from visual angles from which different users observe the user, such that the user can comprehensively evaluate and manage the data of the user in a timely manner to prevent leakage, thereby effectively ensuring security of the user data and providing better experience for the user.

In addition, the user can directly perform an operation of erasing or displaying a graph or an image in a display interface, so as to adjust the data of the user. This manner is easy to implement and enables the operation to be more convenient and direct, thereby more effectively protecting user data and providing better experience for the user.

In several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. A part or all of the units may be selected according to actual requirements to achieve the purpose of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially, or the part contributing to the prior art, or all or a part of the technical solutions may be implemented in a form of a software product. The software product is stored in a storage medium and includes several instructions for instructing a computer device (which may be a personal computer, a server, a network device, or the like) or a processor to perform all or a part of the steps of the methods described in the embodiments of the present application. The foregoing storage medium includes any medium that can store program code, such as a universal serial bus (USB) flash drive, a removable hard disk, a ROM, a RAM, a magnetic disk, or an optical disc.

The foregoing descriptions are merely embodiments of the present application, but are not intended to limit the scope of the present application. An equivalent structural or equivalent process alternation made by using the content of the specification and the drawings of the present application, or an application of the content of the specification and the drawings directly or indirectly to another related technical field, shall fall within the protection scope of the present application.

What is claimed is:

1. A data management method, comprising:
acquiring data published by a first user on the Internet and a shared domain of the data;
expressing the data published by the first user as user data in a uniform format; and
transforming, using a visualization technology, the user data in the uniform format into a graph or an image having a relationship between time and space for display, wherein the graph or the image is a graph or an image having a relationship between time and space at a visual angle of a second user specified in the shared domain of the data.

2. The method according to claim 1, further comprising:
receiving an operation instruction for adjusting the graph or the image;
returning, according to the operation instruction, setting options for adjusting the user data corresponding to the graph or the image;
receiving an instruction of a selected setting option; and
adjusting the user data corresponding to the graph or the image.

3. The method according to claim 2, wherein, after returning the setting options for adjusting the user data corresponding to the graph or the image, the method further comprises presenting, using the visualization technology, adjustment effects corresponding to the setting options to the first user to preview.

4. The method according to claim 1, wherein transforming, using the visualization technology, the user data in the uniform format into the graph or the image having the relationship between time and space for display comprises transforming, using the visualization technology and in combination with an electronic map function, the user data in the uniform format into the graph or the image having the relationship between time and space at the visual angle of the second user specified in the shared domain of the data for display.

5. The method according to claim 1, wherein the data published by the first user comprises explicit data and implicit data.

6. The method according to claim 5, wherein the explicit data comprises information covered by a data protection setting, and wherein the implicit data comprises information comprised in at least one of a text, a picture, and a video that are shared by the first user.

7. The method according to claim 1, wherein expressing the data published by the first user as user data in the uniform format comprises expressing the data published by the first user as user data in a uniform format of “who, when, where, and about what is shared to whom”.

8. A data management device, comprising:
an acquiring module;
an expressing module; and
a displaying module,
wherein the acquiring module is configured to acquire data published by a first user on the Internet and a shared domain of the data, and output the data and the shared domain to the expressing module, wherein the expressing module is configured to express the data published by the first user as user data in a uniform format, and output the user data in the uniform format to the displaying module, wherein the displaying module is configured to transform, using a visualization technology, the user data in the uniform format into a graph or an image having a relationship between time and space for display, and wherein the graph or the image is a graph or an image having a relationship between time and space at a visual angle of a second user specified in the shared domain of the data.

9. The device according to claim 8, further comprising:
a receiving module;
a returning module; and
an adjusting module,
wherein the receiving module is configured to receive an operation instruction for adjusting the graph or the image, and output the operation instruction to the returning module, wherein the returning module is configured to return, according to the operation instruction, setting options for adjusting the user data corresponding to the graph or the image, and wherein the adjusting module is configured to receive an instruction of a selected setting option, and adjust the user data corresponding to the graph or the image.

10. The device according to claim 9, wherein the returning module is further configured to present, using the visualization technology, adjustment effects corresponding to the setting options to the first user to preview.

11. The device according to claim 8, wherein the displaying module is configured to transform, using the visualization technology and in combination with an electronic map function, the user data in the uniform format into the graph or the image having the relationship between time and space at the visual angle of the second user specified in the shared domain of the data for display.

12. The device according to claim 8, wherein the data published by the first user comprises explicit data and implicit data.

13. The device according to claim 12, wherein the explicit data comprises information covered by a data protection setting, and wherein the implicit data comprises information comprised in at least one of a text, a picture, and a video that are shared by the first user.

14. The device according to claim 8, wherein the expressing module is configured to express the data published by the first user as user data in a uniform format of “who, when, where, and about what is shared to whom”.
